(19) United States
(12) Patent Application Publication
(10) Pub. No.: US 2023/0331964 A1
(43) Pub. Date: Oct. 19, 2023

(54) RUBBER COMPOSITION FOR TIRE TREAD AND TIRE

(71) Applicant: Toyo Tire Corporation, Itami-shi (JP)

(72) Inventors: Kazuya Hirabayashi, Itami-shi (JP); Norio Minouchi, Itami-shi (JP)

(73) Assignee: Toyo Tire Corporation, Itami-shi (JP)

(21) Appl. No.: 18/127,962

(22) Filed: Mar. 29, 2023

(30) Foreign Application Priority Data
Apr. 15, 2022 (JP) 2022-067796

(51) Int. Cl. C08L 7/00; C08K 3/36; B60C 1/00

(52) U.S. Cl. CPC C08L 7/00; C08K 3/36; B60C 1/0016; C08L 2205/035

(57) ABSTRACT

A rubber composition for a tire tread according to an embodiment includes, per 100 parts by mass of a rubber component including 40 parts by mass or more of at least one selected from the group consisting of a natural rubber and a synthetic isoprene rubber: 5 to 50 parts by mass of a polyterpene resin having a softening point of 110° C. or more and a glass transition point of 55° C. or more and containing a β-pinene unit; and 50 to 150 parts by mass of silica.

### BACKGROUND OF THE INVENTION

### 1. Field of the Invention

The present invention relates to a rubber composition for a tire tread and also to a tire using the same.

### 2. Description of Related Art

In a rubber composition for forming the tread of a tire, in order to reduce rolling resistance from the viewpoint of fuel efficiency, low heat generation properties are required. In addition, there is also a demand for improved grip performance on wet road surfaces (wet performance). Wet performance and low heat generation properties are contradictory, and techniques for improving them in a well-balanced manner have been examined.

For example, JP2019-530793A describes that the balance between low rolling resistance and excellent wet traction is improved by blending a terpene-based resin into a rubber component selected from the group consisting of a synthetic diene rubber and a natural rubber.

Meanwhile, JP2021-054377A describes that in a rubber composition for forming the tread of a heavy-duty tire, a terpene-based resin is blended into an isoprene-based rubber and a butadiene rubber.

### SUMMARY OF THE INVENTION

As above, JP2019-530793A describes that as a result of blending a terpene-based resin into a rubber component, wet performance and low heat generation properties are improved. However, in the rubber composition specifically disclosed in JP2019-530793A, the rubber component includes a styrene butadiene rubber and a butadiene rubber, and the improving effect on wet performance and low heat generation properties cannot be said to be sufficient. According to studies by the present inventors, it has been found that when the amount of isoprene-based rubber in the rubber component is small, sufficient improving effects cannot be obtained.

JP2021-054377A describes that, as above, a terpene-based resin is blended into an isoprene-based rubber. However, JP2021-054377A aims to improve on-ice performance and wear performance. JP2021-054377A does not disclose blending a terpene-based resin into a system having blended therein 50 parts by mass or more of silica, and wet performance and low heat generation properties cannot be simultaneously achieved.

An object of some embodiments of the invention is to provide a rubber composition for tire tread, which can improve wet performance and low heat generation properties in a well-balanced manner, and also a tire using the same.

A rubber composition for a tire tread according to an embodiment of the invention includes, per 100 parts by mass of a rubber component including 40 parts by mass or more of at least one selected from the group consisting of a natural rubber and a synthetic isoprene rubber: 5 to 50 parts by mass of a polyterpene resin having a softening point of 110° C. or more and a glass transition point of 55° C. or more and containing a β-pinene unit; and 50 to 150 parts by mass of silica.

In the rubber composition for a tire tread described above, it is possible that 100 parts by mass of the rubber component includes 60 to 100 parts by mass of at least one selected from the group consisting of a natural rubber and a synthetic isoprene rubber and 0 to 40 parts by mass of at least one selected from the group consisting of a styrene-butadiene rubber and a butadiene rubber. In addition, it is possible that the silica is present in a proportion of 60 to 120 parts by mass per 100 parts by mass of the rubber component.

A tire according to an embodiment of the invention has a tread made using the rubber composition for a tire tread described above.

According to an embodiment of the invention, wet performance and low heat generation properties can be improved in a well-balanced manner.

### DESCRIPTION OF EMBODIMENTS

A rubber composition for a tire tread according to this embodiment (hereinafter also referred to as “rubber composition”) includes (A) a rubber component, (B) a polyterpene resin, and (C) silica.

### [(A) Rubber Component]

As a rubber component, a diene rubber is used. A diene rubber refers to a rubber with a repeating unit corresponding to a diene monomer having a conjugated double bond, and has a double bond in the polymer backbone. As specific examples of the diene rubber, various diene rubbers commonly used in rubber compositions, such as a natural rubber (NR), a synthetic isoprene rubber (IR), a styrene butadiene rubber (SBR), a butadiene rubber (BR), a nitrile rubber (NBR), a chloroprene rubber (CR), a styrene-isoprene copolymer rubber, a butadiene-isoprene copolymer rubber, and a styrene-isoprene-butadiene copolymer rubber, can be mentioned. The concept of these diene rubbers also encompasses those modified at the terminal or backbone as necessary (e.g., terminally modified SBR) and those modified to impart desired characteristics (e.g., modified NR).

In this embodiment, 100 parts by mass of the rubber component includes 40 parts by mass or more of at least one isoprene-based rubber selected from the group consisting of a natural rubber (NR) and a synthetic isoprene rubber (IR). When the rubber component includes 40 mass % or more of an isoprene-based rubber in this manner, the compatibility of the polyterpene resin with the rubber component improves, and the improving effect on wet performance and low heat generation properties can be enhanced. A natural rubber is preferably used as the isoprene-based rubber.

The amount of isoprene-based rubber in 100 parts by mass of the rubber component is preferably 50 parts by mass or more, more preferably 60 parts by mass or more, still more preferably 70 parts by mass or more, yet more preferably 80 parts by mass or more, and still yet more preferably 90 parts by mass or more, and may also be 100 parts by mass. The rubber component may be composed only of an isoprene-based rubber in this manner, and it is also possible to use an isoprene-based rubber in combination with other diene rubbers. As other diene rubbers for combined use, for example, the above styrene butadiene rubber, butadiene rubber, nitrile rubber, chloroprene rubber, styrene-isoprene copolymer rubber, butadiene-isoprene copolymer rubber, styrene-isoprene-butadiene copolymer rubber, and the like can be mentioned. They can be used alone, and it is also possible to use two or more kinds in combination.

In one embodiment, it is preferable that 100 parts by mass of the rubber component includes 60 to 100 parts by mass of at least one selected from the group consisting of a natural rubber and a synthetic isoprene rubber and 0 to 40 parts by mass of at least one selected from the group consisting of a styrene-butadiene rubber and a butadiene rubber. That is, 100 parts by mass of the rubber component may be the above isoprene-based rubber alone, or may also include 60 parts by mass or more of an isoprene-based rubber and 40 parts by mass or less of a styrene butadiene rubber and/or a butadiene rubber.

For example, 100 parts by mass of the rubber component may include 60 to 90 parts by mass of an isoprene-based rubber and 10 to 40 parts by mass of a styrene butadiene rubber and/or a butadiene rubber. 100 Parts by mass of the rubber component may alternatively include 65 to 85 parts by mass of an isoprene-based rubber and 15 to 35 parts by mass of a styrene butadiene rubber and/or a butadiene rubber.

In one embodiment, it is preferable that the styrene butadiene rubber used in combination with an isoprene-based rubber is a modified styrene butadiene rubber. As modified styrene butadiene rubbers, those having a functional group introduced at the molecular terminal or molecular chain and thus modified with the functional group can be mentioned. The functional group may be, for example, at least one selected from the group consisting of an amino group, a hydroxy group, an alkoxy group, an epoxy group, a silyl group, and a carboxy group. When such a modified styrene butadiene rubber is contained, the dispersibility of silica as a filler can be improved.

### [(B) Polyterpene Resin]

A polyterpene resin is a resin obtained by polymerizing a terpene compound, and has a unit derived from a terpene compound. In this embodiment, a polyterpene resin containing a β-pinene unit is used. A β-pinene unit is a unit derived from p-pinene. Polyterpene resins are highly compatible with the isoprene-based rubber, and thus lead to an increased viscoelastic loss around 0° C., which is an index of wet performance. In addition, aggregation of silica can be prevented, allowing silica to be uniformly dispersed. Therefore, wet performance and fuel efficiency can be simultaneously achieved.

The polyterpene resin is preferably a resin obtained by polymerizing only a terpene compound (terpene monomer). For example, the polyterpene resin may be a homopolymer of β-pinene. Alternatively, the polyterpene resin may also be a copolymer containing an α-pinene unit and a p-pinene unit, that is, may be an α-pinene/β-pinene mixed resin obtained by polymerizing a mixture of α-pinene and β-pinene. An α-pinene unit is a unit derived from α-pinene.

In the α-pinene/β-pinene mixed resin, the mass ratio between the α-pinene unit and the β-pinene unit is not particularly limited, but is preferably 35:65 to 4:96, more preferably 20:80 to 4:96, and still more preferably 10:90 to 4:96. In one embodiment, the β-pinene unit content is preferably 65 to 96 mass %, more preferably 80 to 96 mass %, and still more preferably 90 to 96 mass %. In addition, the α-pinene unit content is preferably 4 to 35 mass %, more preferably 4 to 20 mass %, and still more preferably 4 to 10 mass %.

The polyterpene resin may also be a resin obtained by copolymerizing β-pinene (or α-pinene and β-pinene) together with other terpene compounds. As such other terpene compounds, for example, limonene, δ-3-carene, β-phellandrene, camphene, myrcene, and the like can be mentioned.

In this embodiment, as the polyterpene resin, one having a softening point of 110° C. or more and a glass transition point (Tg) of 55° C. or more is used. As a result of using such a high-softening-point, high-glass-transition-point polyterpene resin, along with using an isoprene-based rubber as the rubber component, wet performance and fuel efficiency can be simultaneously achieved, and also a decrease in wear resistance can be suppressed.

The softening point of the polyterpene resin is preferably 110 to 150° C., and more preferably 110 to 130° C. The softening point is measured in accordance with ASTM D6090 (published in 1997).

The glass transition point of the polyterpene resin is preferably 55 to 81° C., and more preferably 55 to 71° C. The glass transition point is measured in accordance with ASTM D6604 (published in 2013) using a differential scanning calorimeter SC Q2000 manufactured by TA Instruments.

The method for synthesizing a polyterpene resin is not particularly limited. For example, the polyterpene resin can be synthesized by cationically polymerizing a β-pinene-containing monomer using a Lewis acid catalyst. Specific examples of Lewis acid catalysts include, but are not particularly limited to, metal halides (e.g., BF₃, BBr₃, AlF₃, AlBr₃, TiCl₄, TiBr₄, FeCl₃, FeCl₂, SnCl₄, WCl₆, MoCl₅, ZrCl₄, SbCl₃, SbCl₅, TeCl₂, and ZnCl₂), metal alkyl compounds (e.g., Et₃Al, Et₂AlCl, EtAlCl₂, Et₃Al₂Cl₃, (iBu)₃Al, (iBu)₂AlCl, (iBu)AlCl₂, Me₄Sn, Et₄Sn, Bu₄Sn, and Bu₃SnCl), and metal alkoxy compounds (e.g., Al(OR)₃₋ₓClₓ and Ti(OR)_{4-y}Cl_{y} (wherein R represents an alkyl group or an aryl group, x represents an integer of 1 or 2, and y represents an integer of 1 to 3)). Here, Et represents an ethyl group, iBu represents an isobutyl group, Me represents a methyl group, and Bu represents a butyl group.

The polyterpene resin content is, per 100 parts by mass of the rubber component, preferably 5 to 50 parts by mass, more preferably 10 to 40 parts by mass, and still more preferably 15 to 30 parts by mass.

### [(C) Silica]

The rubber composition according to this embodiment has blended therein silica as a filler. As silica, for example, wet silica and dry silica can be mentioned. It is preferable to use wet silica, such as wet-precipitated silica or wet-gelled silica.

In this embodiment, silica is blended in a proportion of 50 to 150 parts by mass per 100 parts by mass of the rubber component. A silica content of 50 parts by mass or more can lead to enhanced effectiveness in simultaneously achieving wet performance and fuel efficiency. The silica content is, per 100 parts by mass of the rubber component, preferably 60 to 120 parts by mass, more preferably 65 to 115 parts by mass, and still more preferably 70 to 110 parts by mass.

The filler to be blended into the rubber composition may be silica alone, and it is also possible to blend carbon black together with silica. The filler preferably contains 80 mass % or more, more preferably 90 mass % or more, of silica. The carbon black content is not particularly limited and may be, per 100 parts by mass of the rubber component, 15 parts by mass or less, 10 parts by mass or less, or 5 parts by mass or less.

Carbon black is not particularly limited, and known various species can be used. Specifically, SAF grade (N100s), ISAF grade (N200s), HAF grade (N300s), FEF grade (N500s), and GPF grade (N600s) (all ASTM grades) can be mentioned. These grades of carbon black can be used alone, and it is also possible to use a combination of two or more kinds.

### [Other Components]

In addition to the above components, the rubber composition according to this embodiment may have blended therein various additives generally used in rubber compositions, such as a silane coupling agent, an oil, zinc oxide, stearic acid, a wax, an antioxidant, a vulcanizing agent, and a vulcanization accelerator.

As silane coupling agents, for example, sulfide silane coupling agents such as bis(3-triethoxysilylpropyl) tetrasulfide, bis(3-triethoxysilylpropyl)disulfide, bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide, mercaptosilane coupling agents such as 3-mercaptopropyltrimethoxysilane, 3-mercaptopropyltriethoxysilane, 3-mercaptopropylmethyldimethoxysilane, 3-mercaptopropyldimethylmethoxysilane, and mercaptoethyltriethoxysilane, and thioester group-containing silane coupling agents such as 3-octanoylthio-1-propyltriethoxysilane, 3-propionylthiopropyltrimethoxysilane, 3-hexanoylthio-1-propyltriethoxysilane, and 3-octanoylthio-1-propyltrimethoxysilane can be mentioned. They can be used alone, and it is also possible to use a combination of two or more kinds.

The silane coupling agent content is not particularly limited, but is preferably 2 to 25 mass % of the amount of silica, that is, 2 to 25 parts by mass per 100 parts by mass of silica. The silane coupling agent content is more preferably 5 to 20 mass % of the amount of silica.

The oil content is not particularly limited and may be, for example, per 100 parts by mass of the rubber component, 0 to 30 parts by mass, 3 to 20 parts by mass, or 5 to 15 parts by mass.

The zinc oxide content is not particularly limited and may be, for example, per 100 parts by mass of the rubber component, 0 to 10 parts by mass, 0.5 to 5 parts by mass, or 1 to 4 parts by mass.

The stearic acid content is not particularly limited and may be, for example, per 100 parts by mass of the rubber component, 0 to 10 parts by mass, 0.5 to 5 parts by mass, or 1 to 4 parts by mass.

The wax content is not particularly limited and may be, for example, per 100 parts by mass of the rubber component, 0 to 10 parts by mass, 0.3 to 5 parts by mass, or 0.5 to 3 parts by mass.

The antioxidant content is not particularly limited and may be, for example, per 100 parts by mass of the rubber component, 0 to 10 parts by mass, 0.5 to 5 parts by mass, or 1 to 4 parts by mass.

As a vulcanizing agent, sulfur is preferably used. The vulcanizing agent content is not particularly limited, but is, per 100 parts by mass of the rubber component, preferably 0.1 to 10 parts by mass, and more preferably 0.5 to 5 parts by mass, and may also be 1 to 3 parts by mass.

As an vulcanization accelerator, for example, sulfenamide-based, thiuram-based, thiazole-based, guanidine-based, and like various vulcanization accelerators can be mentioned. They can be used alone, and it is also possible to use a combination of two or more kinds. The vulcanization accelerator content is not particularly limited, but is, per 100 parts by mass of the rubber component, preferably 0.1 to 7 parts by mass, and more preferably 0.5 to 5 parts by mass, and may also be 1 to 3 parts by mass.

### [Method of Preparing Rubber Composition]

The rubber composition according to this embodiment can be made by kneading in the usual manner using a commonly used mixer, such as a Banbury mixer, a kneader, or a roll. That is, for example, in the first mixing stage (non-productive kneading process), additives other than a vulcanizing agent and a vulcanization accelerator are added to a rubber component together with a polyterpene resin and silica, and mixed. Next, in the final mixing stage (productive kneading step), a vulcanizing agent and a vulcanization accelerator are added to the obtained mixture and mixed. As a result, an unvulcanized rubber composition can be prepared.

### [Application of Rubber Composition]

The rubber composition according to this embodiment can be used as a rubber composition for a tire tread. As tires, pneumatic tires of various sizes for various applications, including passenger car tires, heavy-duty tires for trucks and buses, and the like, can be mentioned.

A tire according to one embodiment is a tire having a tread made using the above rubber composition. That is, a tire according to one embodiment has a tread rubber made of the above rubber composition.

Some tire tread rubbers have a two-layer structure composed of a cap rubber and a base rubber, while others have a single-layer structure having the two integrated. In the case of a single-layer structure, the tread rubber may be formed from the above rubber composition. In the case of a two-layer structure, the outer cap rubber contacting the road surface may be formed from the above rubber composition, the base rubber arranged on the inner side of the cap rubber may be formed from the above rubber composition, or both the cap rubber and the base rubber may be formed from the above rubber composition.

The method for producing a tire is not particularly limited. For example, the above rubber composition is formed into a predetermined shape by extrusion in the usual manner to give an unvulcanized tread rubber member. The tread rubber member is combined with other tire members to make an unvulcanized tire (green tire). Subsequently, vulcanization molding is performed at 140 to 180° C., for example, whereby a tire can be produced.

### EXAMPLES

Examples will be shown hereinafter, but the invention is not limited to these examples.

Components used in the examples and comparative examples are as follows.
Natural rubber: RSS #3
SBR 1: Emulsion-polymerized styrene butadiene rubber (unmodified), “SBR 1502” manufactured by JSR Corporation
SBR 2: Solution-polymerized styrene butadiene rubber (terminally modified with alkoxy and amino groups), “HPR 350” manufactured by JSR Corporation
BR: Butadiene rubber, “Buna CB22” manufactured by ARLANXEO
Carbon black: N339, “SEAST KH” manufactured by Tokai Carbon Co., Ltd.
Silica: “Nipsil AQ” manufactured by Tosoh Silica Corporation
Silane coupling agent: Bis(3-triethoxysilylpropyl) tetrasulfide, “Si69” manufactured by Evonik
Oil: “PROCESS NC140” manufactured by ENEOS Corporation
Zinc oxide: “Type 2 Zinc Oxide” manufactured by Mitsui Mining & Smelting Co., Ltd.
Stearic acid: “Beads Stearic Acid” manufactured by NOF Corporation
Wax: “OZOACE 0355” manufactured by Nippon Seiro Co., Ltd.
Antioxidant: N-phenyl-N′-(1,3-dimethylbutyl)-p-phenylenediamine, “NOCRAC 6C” manufactured by Ouchi Shinko Chemical Industrial Co., Ltd.
Petroleum resin: C5/C9-based hydrocarbon resin, “Petrotack 90” manufactured by Tosoh Corporation
Polyterpene resin (1): α-Pinene/β-pinene mixed resin, “SYLVATRAXX 4150” manufactured by Kraton (α-pinene unit: 5 mass %, β-pinene unit: 95 mass %, softening point: 115° C., Tg: 61° C.)
Polyterpene resin (2): β-pinene resin, “DERCOLYTE S 115” manufactured by DRT (softening point: 114° C., Tg: 70° C.)
Sulfur: “Powder Sulfur” manufactured by Tsurumi Chemical Industry Co., Ltd.
Vulcanization accelerator: “SOXINOL CZ” manufactured by Sumitomo Chemical Co., Ltd.

The evaluation methods in the examples and comparative examples are as follows.

### (1) Wet Performance

A rubber sample obtained by vulcanizing an unvulcanized rubber composition by heating at 170° C. for 15 minutes was used. In accordance with JIS K6394:2007, using a viscoelasticity tester manufactured by Toyo Seiki Seisaku-sho, Ltd., the loss tangent tan δ was measured under the following conditions: static strain (initial strain): 10%, dynamic strain: 1%, frequency: 10 Hz, temperature: 0° C. The results were expressed as indexes taking the tan δ in Comparative Example 1 in Table 1, Comparative Example 5 in Table 3, Comparative Example 6 in Table 3, Comparative Example 7 in Table 4, and Comparative Example 8 in Table 5, respectively, as 100. The larger the index, the larger the tan δ, indicating better wet performance as a tire.

### (2) Low Heat Generation Properties

A rubber sample obtained by vulcanizing an unvulcanized rubber composition by heating at 170° C. for 15 minutes was used. In accordance with JIS K6394:2007, using a viscoelasticity tester manufactured by Toyo Seiki Seisaku-sho, Ltd., the loss tangent tan δ was measured under the following conditions: static strain (initial strain): 10%, dynamic strain: 1%, frequency: 10 Hz, temperature: 60° C. The results were expressed as indexes taking the tan δ in Comparative Example 1 in Table 1, Comparative Example 5 in Table 2, Comparative Example 6 in Table 3, Comparative Example 7 in Table 4, and Comparative Example 8 in Table 5, respectively, as 100. The smaller the index, the smaller the tan δ, that is, the less likely heat is to be generated, indicating better low heat generation properties, and thus better fuel efficiency as a tire.

### (3) Wear Resistance

A rubber sample obtained by vulcanizing an unvulcanized rubber composition by heating at 170° C. for 15 minutes was used. In accordance with JIS K6264, using a Lambourn abrasion tester, the abrasion loss was measured under the following conditions: load: 3 kg, slip ratio: 20%, temperature: 23° C., sand fall rate: 20 g/min. The reciprocals of the abrasion losses were expressed as indexes taking the results in Comparative Example 1 in Table 1, Comparative Example 5 in Table 2, Comparative Example 6 in Table 3, Comparative Example 7 in Table 4, and Comparative Example 8 in Table 5, respectively, as 100. The larger the index, the smaller the abrasion loss, indicating better wear resistance.

### First Experiment Example

Using a Banbury mixer, following the formulations (parts by mass) shown in Table 1 below, first, in the first mixing stage, ingredients excluding sulfur and a vulcanization accelerator were added to a rubber component and kneaded (discharge temperature=160° C.). Next, in the final mixing stage, sulfur and a vulcanization accelerator were added to the obtained kneaded product and kneaded (discharge temperature=90° C.) to prepare a rubber composition. Each obtained rubber composition was evaluated for wet performance, low heat generation properties, and wear resistance.

TABLE 1

| | Comparative | Comparative | Comparative | Comparative | | | |
|---|---|---|---|---|---|---|---|
| | Example 1 | Example 2 | Example 3 | Example 4 | Example 1 | Example 2 | Example 3 |
| Formulation | | | | | | | |
| (parts by mass) | | | | | | | |
| Natural rubber | 100 | 100 | 100 | 100 | 100 | 100 | 100 |
| Carbon black | 5 | 5 | 5 | 5 | 5 | 5 | 5 |
| Silica | 70 | 70 | 70 | 70 | 70 | 70 | 70 |
| Silane coupling | 7.0 | 7.0 | 7.0 | 7.0 | 7.0 | 7.0 | 7.0 |
| agent | | | | | | | |
| Zinc oxide | 3.0 | 3.0 | 3.0 | 3.0 | 3.0 | 3.0 | 3.0 |
| Stearic acid | 2.0 | 2.0 | 2.0 | 2.0 | 2.0 | 2.0 | 2.0 |
| Wax | 1.0 | 1.0 | 1.0 | 1.0 | 1.0 | 1.0 | 1.0 |
| Antioxidant | 2.0 | 2.0 | 2.0 | 2.0 | 2.0 | 2.0 | 2.0 |
| Petroleum resin | — | 20.0 | — | — | — | — | — |
| Polyterpene | — | — | 2.0 | 60.0 | 20.0 | 10.0 | 40.0 |
| resin (1) | | | | | | | |
| Sulfur | 2.0 | 2.0 | 2.0 | 2.0 | 2.0 | 2.0 | 2.0 |
| Vulcanization | 1.0 | 1.0 | 1.0 | 1.0 | 1.0 | 1.0 | 1.0 |
| accelerator | | | | | | | |
| Evaluation (Index) | | | | | | | |
| Wet performance | 100 | 120 | 105 | 140 | 125 | 120 | 135 |
| Low heat generation | 100 | 130 | 100 | 110 | 95 | 97 | 99 |
| properties | | | | | | | |
| Wear resistance | 100 | 80 | 100 | 85 | 98 | 100 | 93 |

The results are as shown in Table 1. When a petroleum resin was blended into a blend system using a natural rubber alone as the rubber component and containing a considerable amount of silica, as shown in Comparative Example 2, wet performance greatly improved, but low heat generation properties and wear resistance significantly deteriorated. This is presumably because in the case where a petroleum resin is added to a natural rubber-based blend system, silica aggregation occurs.

In contrast, in Examples 1 to 3 where a specified amount of polyterpene resin (1) was blended, while maintaining or improving low heat generation properties, wet performance significantly improved relative to Comparative Example 1. In addition, a decrease in wear resistance was also suppressed. Meanwhile, in Comparative Example 3 where the amount of polyterpene resin (1) blended was small, almost no performance-improving effect was observed. Conversely, in Comparative Example 4 where the amount of polyterpene resin (1) blended was large, although wet performance was excellent, low heat generation properties and wear resistance decreased.

### Second Experiment Example

A rubber composition was prepared in the same manner as in the first experiment example, except for following the formulations (parts by mass) shown in Table 2 below. Each obtained rubber composition was evaluated for wet performance, low heat generation properties, and wear resistance. The results are as shown in Table 2.

TABLE 2

| | Comparative | Example |
|---|---|---|
| | Example 5 | 4 |
| Formulation (parts by mass) | | |
| Natural rubber | 70 | 70 |
| SBR 1 | 30 | 30 |
| Carbon black | 5 | 5 |
| Silica | 95 | 95 |
| Silane coupling agent | 9.5 | 9.5 |
| Oil | 5 | 5 |
| Zinc oxide | 2.0 | 2.0 |
| Stearic acid | 2.0 | 2.0 |
| Wax | 2.0 | 2.0 |
| Antioxidant | 2.0 | 2.0 |
| Petroleum resin | 15.0 | — |
| Polyterpene resin (1) | — | 15.0 |
| Sulfur | 1.5 | 1.5 |
| Vulcanization accelerator | 1.0 | 1.0 |
| Evaluation (Index) | | |
| Wet performance | 100 | 105 |
| Low heat generation properties | 100 | 85 |
| Wear resistance | 100 | 112 |

### Third Experiment Example

A rubber composition was prepared in the same manner as in the first experiment example, except for following the formulations (parts by mass) shown in Table 3 below. Each obtained rubber composition was evaluated for wet performance, low heat generation properties, and wear resistance. The results are as shown in Table 3.

TABLE 3

| | Comparative | Example |
|---|---|---|
| | Example 6 | 5 |
| Formulation (parts by mass) | | |
| Natural rubber | 70 | 70 |
| SBR 2 | 30 | 30 |
| Carbon black | 5 | 5 |
| Silica | 110 | 110 |
| Silane coupling agent | 11.0 | 11.0 |
| Oil | 10 | 10 |
| Zinc oxide | 2.0 | 2.0 |
| Stearic acid | 2.0 | 2.0 |
| Wax | 2.0 | 2.0 |
| Antioxidant | 2.0 | 2.0 |
| Petroleum resin | 20.0 | — |
| Polyterpene resin (1) | — | 20.0 |
| Sulfur | 1.5 | 1.5 |
| Vulcanization accelerator | 1.0 | 1.0 |
| Evaluation (Index) | | |
| Wet performance | 100 | 106 |
| Low heat generation properties | 100 | 83 |
| Wear resistance | 100 | 110 |

### Fourth Experiment Example

A rubber composition was prepared in the same manner as in the first experiment example, except for following the formulations (parts by mass) shown in Table 4 below. Each obtained rubber composition was evaluated for wet performance, low heat generation properties, and wear resistance. The results are as shown in Table 4.

TABLE 4

| | Comparative | Example |
|---|---|---|
| | Example 7 | 6 |
| Formulation (parts by mass) | | |
| Natural rubber | 80 | 80 |
| BR | 20 | 20 |
| Carbon black | 5 | 5 |
| Silica | 60 | 60 |
| Silane coupling agent | 6.0 | 6.0 |
| Zinc oxide | 3.0 | 3.0 |
| Stearic acid | 2.0 | 2.0 |
| Wax | 1.0 | 1.0 |
| Antioxidant | 2.0 | 2.0 |
| Petroleum resin | 20.0 | — |
| Polyterpene resin (2) | — | 20.0 |
| Sulfur | 1.5 | 1.5 |
| Vulcanization accelerator | 1.0 | 1.0 |
| Evaluation (Index) | | |
| Wet performance | 100 | 109 |
| Low heat generation properties | 100 | 90 |
| Wear resistance | 100 | 115 |

### Fifth Experiment Example

A rubber composition was prepared in the same manner as in the first experiment example, except for following the formulations (parts by mass) shown in Table 5 below. Each obtained rubber composition was evaluated for wet performance, low heat generation properties, and wear resistance. The results are as shown in Table 5.

TABLE 5

| | Comparative | Comparative |
|---|---|---|
| | Example 8 | Example 9 |
| Formulation (parts by mass) | | |
| Natural rubber | 20 | 20 |
| SBR 1 | 80 | 80 |
| Carbon black | 5 | 5 |
| Silica | 95 | 95 |
| Silane coupling agent | 9.5 | 9.5 |
| Oil | 5 | 5 |
| Zinc oxide | 2.0 | 2.0 |
| Stearic acid | 2.0 | 2.0 |
| Wax | 2.0 | 2.0 |
| Antioxidant | 2.0 | 2.0 |
| Petroleum resin | 15.0 | — |
| Polyterpene resin (1) | — | 15.0 |
| Sulfur | 1.5 | 1.5 |
| Vulcanization accelerator | 1.0 | 1.0 |
| Evaluation (Index) | | |
| Wet performance | 100 | 95 |
| Low heat generation properties | 100 | 105 |
| Wear resistance | 100 | 108 |

As shown in Tables 2 to 4, also in a blend system of natural rubber/styrene butadiene rubber and a blend system of natural rubber/butadiene rubber, as in the case of the blend system of a natural rubber alone, when a polyterpene resin (1) or a polyterpene resin (2) was blended as in Examples 4 to 6, compared to Comparative Examples 5 to 7 where a petroleum resin was blended, it was possible to improve both wet performance and low heat generation properties, and wear resistance was also excellent.

Meanwhile, as shown in Table 5, in a blend system with a low natural rubber proportion in the rubber component, when a polyterpene resin (1) was blended as in Comparative Example 9, wet performance and low heat generation properties deteriorated relative to Comparative Example 8 where a petroleum resin was blended. This is presumably because in a blend system with a low natural rubber proportion, the compatibility of the polyterpene resin (1) with the rubber component decreases.

Incidentally, with respect to the various numerical ranges described herein, the upper and lower limits thereof can be arbitrarily combined, and all such combinations are incorporated herein as preferred numerical ranges. In addition, the description of a numerical range “X to Y” means X or more and Y or less.

Although some embodiments of the invention have been described above, these embodiments are presented as examples and not intended to limit the scope of the invention. These embodiments can be implemented in other various modes, and, without departing from the gist of the invention, various omissions, substitutions, and changes can be made thereto. These embodiments, as well as omissions, substitutions, and changes thereto, etc., fall within the scope and gist of the invention, and also fall within the scope of the claimed invention and its equivalents.

What is claimed is:

1. A rubber composition for a tire tread, comprising, per 100 parts by mass of a rubber component including 40 parts by mass or more of at least one selected from the group consisting of a natural rubber and a synthetic isoprene rubber:
5 to 50 parts by mass of a polyterpene resin having a softening point of 110° C. or more and a glass transition point of 55° C. or more and containing a β-pinene unit; and
50 to 150 parts by mass of silica.

2. The rubber composition for a tire tread according to claim 1, wherein
100 parts by mass of the rubber component includes 60 to 100 parts by mass of at least one selected from the group consisting of a natural rubber and a synthetic isoprene rubber and 0 to 40 parts by mass of at least one selected from the group consisting of a styrene-butadiene rubber and a butadiene rubber, and
the silica is present in a proportion of 60 to 120 parts by mass per 100 parts by mass of the rubber component.

3. The rubber composition for a tire tread according to claim 1, wherein the rubber component further includes a modified styrene-butadiene rubber.

4. The rubber composition for a tire tread according to claim 1, wherein the polyterpene resin is a homopolymer of β-pinene.

5. The rubber composition for a tire tread according to claim 1, wherein the polyterpene resin is a copolymer containing an α-pinene unit and a β-pinene unit, and the mass ratio of between the α-pinene unit and the β-pinene units is 35:65 to 4:96.

6. A tire having a tread made using the rubber composition for a tire tread according to claim 1.

7. A tire having a tread made using the rubber composition for a tire tread according to claim 2.

8. A tire having a tread made using the rubber composition for a tire tread according to claim 3.

9. A tire having a tread made using the rubber composition for a tire tread according to claim 4.

10. A tire having a tread made using the rubber composition for a tire tread according to claim 5.
